(19) United States
(12) Patent Application Publication
(10) Pub. No.: US 2015/0270768 A1
(43) Pub. Date: Sep. 24, 2015

(54) Sealed Magnetic Drive for Rotary Machine

(71) Applicant: Fuglesangs Subsea AS, Oslo (NO)

(72) Inventor: Arve Sinnerud, Oslo (NO)

(73) Assignee: FUGLESANGS SUBSEA AS, Oslo (NO)

(21) Appl. No.: 14/516,079

(22) Filed: Oct. 16, 2014

Related U.S. Application Data
(63) Continuation of application No. 14/218,640, filed on Mar. 18, 2014.

(51) Int. Cl. H02K 49/10; H02K 5/128

(52) U.S. Cl. CPC H02K 49/104; H02K 5/128

(57) ABSTRACT

A rotary machine is disclosed which is coupled to a motor by a magnetic coupling. An outer magnet drives an inner magnet which is fixed to a rotary shaft which turns a rotor of the machine. The inner magnet is in an enclosure filled with pressurized fluid. The outer magnet is driven by a motor, both the outer magnet and motor being placed in a pressurized cavity outside of the enclosure for the inner magnet. Such arrangement enables the machine, including the motor to be submerged in the sea or chemical liquid while preventing seawater or liquid chemical contamination of the motor and the rotating machine.

### CROSS REFERENCE

This application is a continuation of U.S. Ser. No. 14/218,640, which was filed on Mar. 18, 2014, entitled “Sealed Magnetic Drive for Rotary Machine” and is incorporated by reference herein for all purposes.

### BACKGROUND OF THE INVENTION

1. Field of the Invention

This invention concerns a rotary machine coupled to a drive source by a magnetic coupling. In particular, the invention concerns a sealing arrangement for such a machine which is submerged in liquid, which may be water or a chemical liquid in a tank.

2. Description of the Prior Art

Machines are well known for compressing or expanding a fluid for the chemical industry or for oil and gas processing. The machines have included a rotor mounted on a stator to rotate in a fluid chamber, a rotary shaft on which the rotor is fixed, and which extends outside the stator through a shaft passage thereof Bearings are mounted in the shaft passage for guiding and supporting the shaft. Outside the stator, the rotary shaft is connected to a drive shaft from a drive source such as a motor or a turbine or the like.

U.S. Pat. No. 5,334,004 to Lefevre et al. shows a compressor or turbine where the drive shaft is magnetically coupled to an external drive source but with the internal drive shaft enclosed in a bell filled with a liquid under pressure. A closed enclosure is formed around the shaft passage which receives the shaft which drives the rotor. The Lefevre arrangement prevents leakage of dangerous gas from the inside to the outside of the rotary machine.

### IDENTIFICATION OF THE OBJECTS OF THE INVENTION

A primary object of the invention is to provide a sealing arrangement for a magnetically coupled rotating machine.

Another object of the invention is to provide system reliability for a rotary machine which is installed in a submerged environment such as water or a liquid chemical.

### SUMMARY OF THE INVENTION

The machine of the invention includes a housing with a rotor mounted on a shaft supported by bearings which are separated, according to a first embodiment, from the fluid being processed by the rotor by means of high pressure, heavy duty mechanical seals. A barrier fluid between the mechanical seals and a rear magnetic housing, or “bell,” is provided under high pressure. According to a second embodiment, the seals of the first embodiment are eliminated such that the rotor pressure is applied directly to the shaft bearings. In both embodiments, a cavity on the outside of the housing surrounds one magnet of the magnetic coupling and is filled with another liquid under pressure that enables the entire arrangement to be submerged in a deep sea environment or in a tank containing liquid chemicals while providing a barrier from seawater or chemicals entry into the housing.

### BRIEF DESCRIPTION OF THE DRAWINGS

FIG. 1 is a schematic illustration of the rotating machine of the invention which has a rotor magnetically coupled to an external power source and with an external magnet of the coupling placed in a liquid pressurized cavity; and

FIG. 2 is an alternative embodiment of the invention where the magnetic elements of the magnetic coupling of FIG. 1 are reversed and with seals between the driven rotor and bearings removed from the embodiment of FIG. 1.

### DESCRIPTION OF EMBODIMENTS OF THE INVENTION

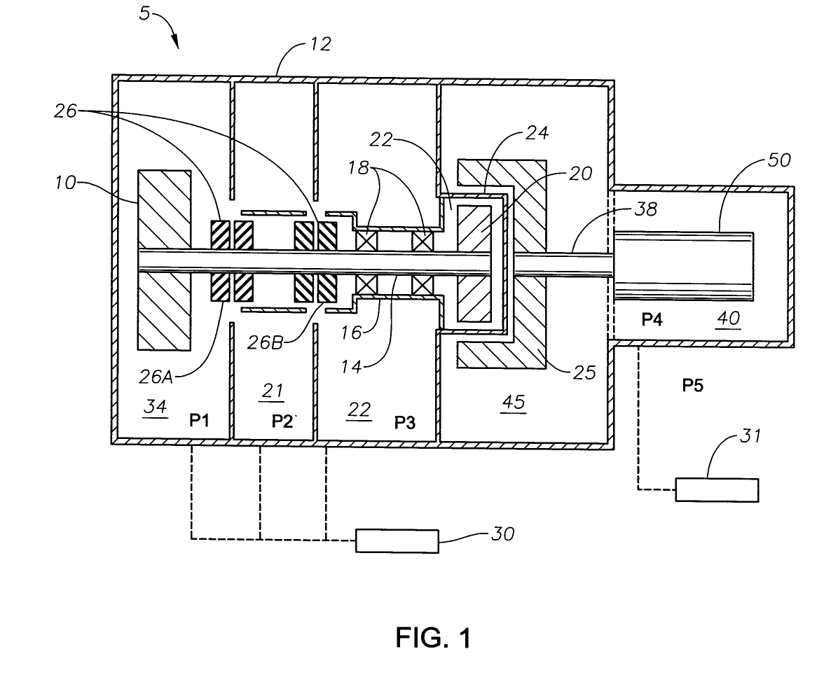

FIG. 1 shows the invention of a rotating machine 5 with a rotor 10 disposed in a housing 12. The rotor is driven by a rotary shaft 14 which is positioned within a shaft passage 16 disposed within housing 12. Bearings 18 provide rotational support for the shaft 14 within shaft passage 16.

An internal magnet 20 is fixed to an interior end of rotary shaft 14. A first enclosure 22 surrounds the internal magnet 20 and is formed by the bell shaped member 24 and the shaft passage 16. The first enclosure extends to a seal structure 26 which may be a dual or single mechanical seal. A dual seal 26 is illustrated in FIG. 1, but a single seal can be provided.

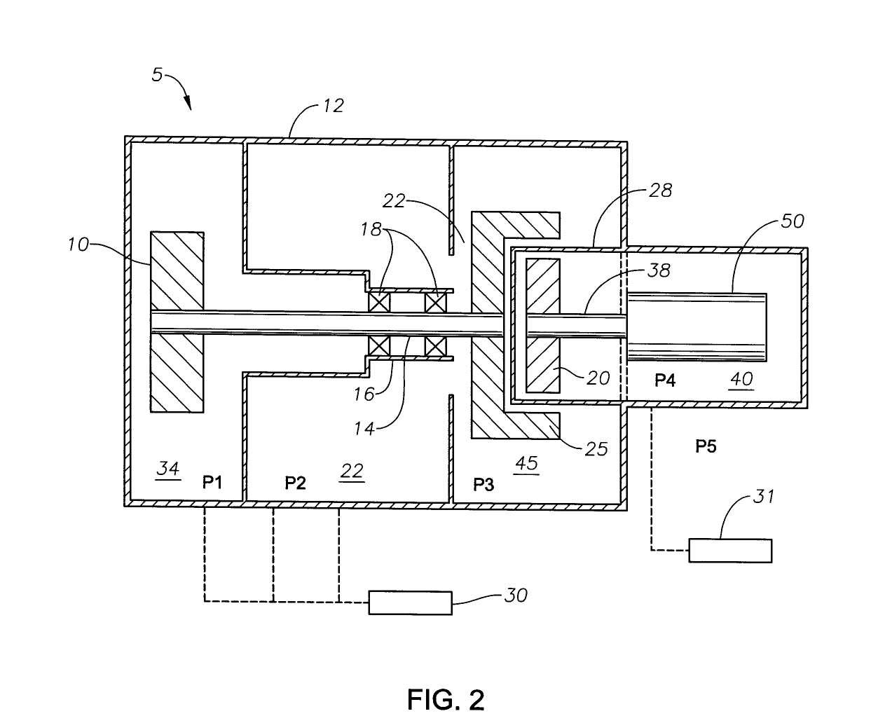

As illustrated in FIG. 1, the first enclosure 22 can be pressurized to a pressure P3 by Pressure Source/Compensator 30. Enclosure 22 serves as a barrier cavity. Another barrier cavity may be provided between dual seals 26 (if provided) and can be pressurized to a pressure P2 by the Pressure Source/Compensator 30. Dual or single seals may be eliminated from the embodiment of FIG. 1 such that bearings 18 are exposed to process fluid in cavity 34. Such an arrangement is shown in FIG. 2.

The rotary shaft 14 is driven by magnetic coupling between internal magnet 20, inside bell 24, and external magnet 25 which is rotated via motor shaft 38 by a motor 50 disposed in a motor cavity 40. Pressurized liquid is provided in the motor cavity 40 and a second enclosure 45 which surrounds the external magnet and motor shaft 38. The motor cavity 40 and second enclosure 45 are pressurized to a pressure P4 by a pressure source/compensator 31. The pressure P4 may be slightly higher than the ambient pressure P5 for subsea conditions (or chemical tank conditions) which could typically be from 0 to 300 bar.

FIG. 2 illustrates an alternative arrangement of the rotating machine where the seals 26 of FIG. 1 have been eliminated and the magnetic elements between shafts 14 and 38 have been reversed. In other words, magnet 20 is attached to shaft 38, and magnet 25 is attached to shaft 14.

The entire machine of FIG. 1 or FIG. 2 may be immersed in water or in chemical liquids of a tank under ambient pressure condition P5.

The arrangement described above provides a sealing mechanism for rotating machines such as a pump, cyclone, separator, or turbine for either water, hydrocarbons, chemicals or slurry applications. The arrangement is especially designed for such rotating machines which are submerged in the sea. The arrangement provides sealing of components to achieve system reliability. It also enables separation of the process fluid, which may contain sand particles, from other vital components such as bearings and the magnetic coupling.

As illustrated in FIG. 1, pressurized liquids or barrier fluids between the mechanical seals 26 and the bell 24 are pressurized to high differential pressures. A second enclosure 45 outside the bell 24 has another pressure compensated liquid provided by pressure source/compensator 31 that enables the entire rotating machine 5 to be submerged deeply in the ocean while providing two barriers against seawater contamination in case of a mechanical seal 26 failure.

The dual mechanical seals 26A, 26B, one 26A facing the process cavity 34, the other 26B facing the barrier cavity 22, provide added security against failure. If sand particles or the like were to penetrate the seal 26A facing the process cavity 34, a second seal barrier 26B exists to inhibit particle intrusion into the cavity 22 in which the bearings are positioned.

It is preferred to provide seals 26 which are capable of handling “reverse” pressure. Such a condition would exist where pressure P1 in process cavity 34 is larger than pressure P2 or P3 in barrier cavities 21, 22. Seals 26A, 26B are preferably hard surface seals so as to be able to withstand operation with sand particles in the liquid.

Although dual mechanical seals are preferred, a single mechanical seal can be provided, whereby a single pressure is provided rather than the two pressure P2 and P3 as illustrated in FIG. 1.

As indicated above, FIG. 2 shows an arrangement where no seals are provided at all between rotor 10 and bearings 18 where the pressure P3 in enclosures 22 and 45 is maintained at the same pressure P1 of fluid in enclosure 34.

The arrangements of FIGS. 1 and 2 eliminate the need for a motor 50 with a pressure containing shell, since the pressure P4 is not the same as the barrier fluid pressure P3, due to the pressure containing capability of the bell 24 in FIG. 1 and the surround 28 of FIG. 2. As a result, the motor pressure P4 is equal to or slightly higher than ambient pressure condition P5 in a submerged condition in the sea or in a chemical tank. This feature allows the material thickness of the motor shell to be reduced which provides advantages such as less cooling requirements and weight reduction. Furthermore, the arrangement of FIG. 1 allows “dry running,” (without process fluid) in the process cavity 34, without compromising system reliability, because the bearings 18 are lubricated by the barrier fluids applied to the barrier cavities 21, 22.

As illustrated in FIG. 1, two mechanical seals 26A, 26B each mounted on the rotary shaft 14 provide a dual barrier between the process cavity 34 and the bearings 18. The barrier cavity is pressurized by the same pressure source/compensator 30 that generates overpressure P2 or P3>P 1. This arrangement provides significant amounts of barrier fluid leakage from seals 26A, 26B so as to inhibit possible intrusion on the hard surfaces of the mechanical seals 26 while ultimately protecting the load carrying bearings 18 from contaminates in the process fluid of process cavity 34.

The motor 50 and motor cavity 40 can be pressurized by a liquid, shared with the liquid in the second enclosure 45. The liquid is supplied and pressure compensated by source/compensator 31. The pressure P4 is compensated toward the ambient pressure condition P5 of the subsea environment or chemical liquid in a chemical tank. The pressure P4 of the second enclosure 45 of FIG. 1 may or may not be lower than the barrier fluid pressure P3 or P2.

1. A rotary machine for treating fluids under pressure, comprising,
a housing (12) in which an annular fluid flow process cavity (34) is formed and having a shaft passage (16) formed in the housing,
a rotor (10) mounted in said process cavity (34),
a rotary shaft (14) to which the rotor (10) is fixed, said shaft extending outside said process cavity (34) through said shaft passage (16),
bearings (18) mounted between said rotary shaft (14) and said shaft passage (16), said bearings arranged and designed for guiding and supporting the shaft in the shaft passage,
a bell (24) sealingly placed around said shaft passage (16), said bell forming a first barrier cavity (22) which is separated from said annular fluid flow process cavity (34),
a rotation mechanism including an inner permanent magnet (20) fixed to said rotary shaft (14) inside said first barrier cavity (22) and an external magnet (25) fixed to a motor shaft (38) outside said first barrier cavity (22), whereby rotation of said motor shaft (38) transfers rotation to said rotary shaft (14) by magnetic coupling between the external magnet (25) to the internal magnet (20),
said rotary machine having a second enclosure (45) filled with a pressurized fluid, said second enclosure (45) placed around and outside of said bell (24) and around said motor shaft (38),
wherein said external magnet (25) is disposed in said second enclosure (45).

2. The rotary machine of claim 1 further comprising,
a motor (50) in said second enclosure (45) which turns said motor shaft (38).

3. The rotary machine of claim 1 wherein,
said rotor (10) is arranged and designed in said fluid flow process cavity (34) as a pump.

4. The rotary machine of claim 1 wherein, said rotor (10) is arranged and designed in said fluid flow process cavity (34) as a cyclone or separator.

5. The rotary machine of claim 1 wherein,
said rotor (10) is arranged and designed in said fluid flow process (34) as a turbine for power production or compression.

6. The rotary machine of claim 1 wherein,
said bearings (18) in said barrier cavity (22) are exposed directly to said process cavity (34).

7. The rotary machine of claim 1 further comprising,
a first seal (26A) mounted on said rotary shaft (14) which faces said fluid flow process cavity (34), and
a second seal (26B) mounted on said rotary shaft (14) which faces said barrier cavity 22.

8. The rotary machine of claim 1 further comprising,
a seal structure (26) mounted on said rotary shaft (14) and positioned between said fluid flow process cavity (34) and said first barrier cavity (22).

9. The rotary machine of claim 8 of which said seal structure (26) includes,
a first seal (26A) mounted on said rotary shaft (34) facing said fluid flow process cavity (34), and
a second seal (26B) mounted on said rotary shaft (34) facing said sealed barrier cavity (21),
wherein said first and second seals (26A, 26B) are spread apart from each other, with a space between said first and second seals defining an additional barrier cavity (21).

10. The rotary machine of claim 9 wherein,
a first pressure P1 is established in said fluid flow process cavity (34),
a second pressure P2 is established in said additional barrier cavity (21), and
a third pressure P3 is established in said first barrier cavity (22).

11. The rotary machine of claim 10 wherein,
said seals (26A, 26B) are arranged and designed to inhibit particle intrusion into said first barrier cavity (22).

12. The rotary machine of claim 9 wherein,
said third pressure P3 is greater than said second pressure P2, and
said second pressure P2 is greater than said first pressure P1.

13. The rotary machine of claim 11 wherein,
said seal structure (26) is designed and arranged to handle reverse pressure where said first pressure P1 is greater than said second pressure P2 and said second pressure P2 is greater than said third pressure P3.

14. The rotary machine of claim 2 wherein pressure in said second enclosure (45) is pressurized to a level P4 toward the ambient pressure condition P5 of the subsea environment or chemical liquid in which said machine is immersed.

15. A rotary machine (5) for treating fluids while being submerged in a liquid, comprising
a rotor (10) disposed in a process cavity (34),
a rotary shaft (14) connected to said rotor (10),
said rotary shaft (14) rotated by a mechanism that includes a first magnet (20, 25) coupled to said shaft (14) and a second magnet (25, 20) arranged to turn the first magnet (20, 25) by magnetic coupling,
and a motor (50) for rotating said second magnet (25, 20),
said second magnet (25, 20) and said motor (50) being disposed in a housing (40) which is under pressure (P4) that is equal to or greater than the pressure of water or chemical liquid (P5) in which said machine (5) is submerged.
